(19) United States
(12) Patent Application Publication
(10) Pub. No.: US 2011/0026190 A1
(43) Pub. Date: Feb. 3, 2011

(54) SOLID ELECTROLYTIC CAPACITOR, METHOD FOR MANUFACTURING SAME, AND BASE FOR SOLID ELECTROLYTIC CAPACITOR

(75) Inventor: Hideki Oohata, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/094,502

(22) PCT Filed: Nov. 22, 2006
(86) PCT No.: PCT/JP2006/323349

§ 371 Date: Aug. 18, 2009

Related U.S. Application Data
(60) Provisional application No. 60/740,654, filed on Nov. 30, 2005.

(30) Foreign Application Priority Data
Nov. 22, 2005 (JP) 2005-337327

(51) Int. Cl. H01G 9/025

(52) U.S. Cl. 361/523

(57) ABSTRACT

A solid electrolyte capacitor comprising a solid electrolyte capacitor substrate having a porous surface layer or layers on the surface or surfaces of the substrate, which substrate has a masking layer in the boundary region between an anode region of the substrate and a cathode region of the substrate, wherein said masking layer has been formed from a solution or dispersion of a heat-resistant resin or a precursor thereof; and said masking layer contains 0% to 0.1% by mass, based on the mass of the heat-resistant resin or the precursor, of an additive for modifying the masking layer, which additive is other than a silane coupling agent. The masking layer exhibits a high insulation and the solid electrolyte capacitor has enhanced reliability.

### CROSS-REFERENCE TO RELATED APPLICATION

This application was filed pursuant to 35 U.S.C. 111(a) with claiming the benefit of filing date of U.S. Provisional Application Ser. No. 60/740, 654 filed Nov. 30, 2005 under the provision of 35 U.S.C. 111(b) pursuant to 35 U.S.C. 119(e) (1).

### TECHNICAL FIELD

This invention relates to a solid electrolyte capacitor, a process for producing the same, and a substrate for a solid electrolyte capacitor. More particularly, it relates to a solid electrolyte capacitor comprising a substrate having a porous surface layer or layers on the surface or surfaces of the substrate, which substrate has a masking layer having high insulating property formed on a boundary region between an anode region of the substrate and a cathode region of the substrate, wherein the anode region comprises a metal base sheet on which a solid electrolyte layer is not formed and the cathode region comprises a solid electrolyte layer or an electrically conductive layer formed from, for example, an electrically conductive paste on the solid electrolyte layer.

### BACKGROUND ART

In general, solid electrolytic capacitors are made by a process comprising (i) etching a surface of an anode comprised of a metal having a valve action such as aluminum, tantalum, niobium, titanium or alloys of these metals to be thereby roughened to form micropores having a size of micron order, thus enhancing the surface area; (ii) subjecting the thus-etched anode surface to a chemical formation to form an dielectric oxide film thereon; (iii) dipping with or forming a solid electrolyte on the chemically formed film with a separator intervening between an anode region and a cathode region thus forming a solid electrolyte layer, (iv) forming a cathode electroconductive layer comprised of a carbon paste and/or a metal-containing electro-conductive paste on the cathode region of the solid electrolyte layer, (v) welding a lead frame outer electrodes to a thus-obtained assembly, and (vi) encapsulating the assembly with an insulating resin such as an epoxy resin to form a sheathed solid electrolyte capacitor.

A solid electrolyte capacitor made by using a conductive polymeric material as a solid electrolyte is advantageous over a solid electrolyte capacitor made by using another material such as, for example, manganese dioxide in that the equivalence series resistance and leakage current of the former solid electrolyte capacitor can be lowered, as compared with those of the latter solid electrolyte capacitor, and thus, the former solid electrolyte capacitor is especially suitable for high-performance and compact electronic instruments. Therefore, many solid electrolyte capacitors and processes for making the capacitors have been proposed as the former electrolytic capacitors.

In the production of the high-performance solid electrolyte capacitor using a conductive polymer, especially from a metal foil having a valve action, it is indispensable that an anode terminal-forming anode region of the metal foil is electrically insulated from a cathode region formed with a conductive layer comprising a conductive polymer. However, at the step of dipping with or forming a solid electrolyte on a chemically formed foil, a solid electrolyte layer sometimes crawls, i.e., penetrates into an anode region. Such crawling or penetration of a solid electrolyte layer causes insulation failure between the anode region and the cathode region.

As examples of the means for electrically insulating the anode region of the solid electrolyte capacitor from the cathode region thereof, there can be mentioned a process wherein a solution containing a polyamic acid salt is electrodeposited on at least part of the region in which a solid electrolyte has not been formed area to form a polyamic acid film, and thereafter the polyamic acid film is heated to be thereby dehydrated and hardened to form a polyimide film (see Patent Document 1, cited below); and a process for making a solid electrolyte, which comprises a step of coating a dielectric film for a solid electrolyte capacitor with a masking material solution for forming on the dielectric film a masking layer capable of penetrating into the dielectric film (see Patent Document 2, cited below).

The above-mentioned masking material solution has usually incorporated therein various additives for modifying the masking layer for enhancing an adhesion to other substrates, a surface flatness and a leveling. For example, it is described in Patent Document 3, cited below, that a preferable masking material solution containing a polyimide precursor capable of giving a highly heat-resistant polyimide film, with a high concentration and a low-solution viscosity, preferably contains a surface tension modifier and a thixotropic agent.

The surface-tension modifier preferably includes a silicone surface tension modifier such as silicone oil, and surface tension modifiers such as higher fatty acid glycerin esters, higher alcohol boric acid esters and fluorine-containing surface active agents. The amount of surface tension modifiers is known as usually in the range of 0.01% to 1% by weight based on the weight of masking material.

Patent Document 1: Japanese Unexamined Patent Publication No. H5-47611

Patent Document 2: WO00/67267.

Patent Document 3: Japanese Unexamined Patent Publication No. H10-182820

### DISCLOSURE OF THE INVENTION

### Problems to be Solved by the Invention

A polyimide film can be formed even on the walls of micropores by process of forming a polyimide film by electrodeposition (patent document 1), which is in a striking contrast to the conventional coating process. However, the electrodeposition is not advantageous in view of high production cost and a high-temperature hydration step required for the formation of the polyimide film.

In the process for making a solid electrolyte, described in the patent document 2, which comprises a step of coating a dielectric film with a masking material solution for forming a masking layer on the dielectric film, which solution is capable of penetrating into the dielectric film, there is a problem such that the penetration of the masking material solution is not sufficiently penetrated into the depth of micropore portions, which varies depending upon the viscosity of the masking material, and further upon the surface state of the dielectric film and the micropore-formed state such as distribution of micropores in the dielectric film.

Even in the case when a masking material solution containing a polyimide precursor capable of giving a highly heat-resistant polyimide film, with a high concentration and a low-solution viscosity, is used as taught in the patent document 3, there is still a problem such that the penetration of the masking material solution is not sufficiently penetrated into the depth of an etched aluminum layer. Thus the masking material for insulation between the anode region of capacitor and the cathode region thereof is not optimized.

Therefore the conventional masking means is not sufficiently satisfied, and a masking material capable of insulating the anode region of capacitor from the cathode region thereof with a high reliability is still eagerly desired.

### Means for Solving the Problems

In view of the foregoing problems in the prior art, primary objects of the present invention are to provide an anode substrate for a solid electrolyte capacitor capable of insulating an anode region of capacitor from a cathode region thereof with high reliability, which gives a solid electrolyte capacitor having a stable quality and can be made with a high productivity (which anode substrate is hereinafter referred to as merely “substrate for solid electrolyte capacitor” in the description and the claims); and further to provide a process for producing the anode substrate.

The present inventors made an extensive research to achieve the above-mentioned objects, and surprisingly found that a masking material solution which does not have incorporated therein an additive for modifying a masking layer, other than a silane-coupling agent, and can give an insulating layer exhibiting a high insulation property with a high reliability.

Thus, in accordance with the present invention, there are provided the following solid electrolyte capacitor, substrate for the solid electrolyte capacitor, and a process for producing the solid electrolyte capacitor.

(1) A solid electrolyte capacitor comprising a solid electrolyte capacitor substrate having a porous surface layer or layers on the surface or surfaces of the substrate, which substrate has a masking layer on a boundary region between an anode region of the substrate and a cathode region of the substrate, characterized in that said masking layer is formed from a solution or dispersion of a heat-resistant resin or a precursor thereof; and said masking layer contains 0% to 0.1% by mass, based on the mass of the heat-resistant resin or the precursor, of an additive for modifying the masking layer, which additive is other than a silane coupling agent.

(2) The solid electrolyte capacitor as described in (1) above, wherein the additive for modifying the masking layer is at least one agent selected from the group consisting of a surface-tension modifier and a thixotropic agent.

(3) The solid electrolyte capacitor as described in (1) or (2) above, wherein said solution or dispersion of a heat-resistant resin or a precursor thereof is a solution of a polyimide resin or a varnish of polyamic acid.

(4) The solid electrolyte capacitor as described in (1) above, wherein said solution or dispersion of a heat-resistant resin or a precursor thereof is a solution of a polyimide resin or a varnish of polyamic acid, wherein said solution of polyimide resin or said varnish of polyamic acid contains 0.1% to 5% by mass, based on the mass of the polyimide resin or the polyamic acid, of a silane coupling agent; and said solution of polyimide resin or said varnish of polyamic acid further contains at least one agent selected from the group consisting of a surface-tension modifier and a thixotropic agent as the additive for modifying the masking layer wherein the total amount of the surface-tension modifier and the thixotropic agent is in the range of 0% to 0.1% by mass, based on the mass of the solution of polyimide resin or the varnish of polyamic acid.

(5) A substrate for a solid electrolyte capacitor which substrate has a porous surface layer or layers on the surface or surfaces of the substrate, and has a heat-resistant resin layer formed on at least part of the substrate, characterized in that said heat-resistant resin layer is formed from a solution or dispersion of a heat-resistant resin or a precursor thereof, wherein said heat-resistant resin layer contains 0% to 0.1% by mass, based on the mass of the heat-resistant resin or the precursor, of an additive for modifying the heat-resistant resin layer, which additive is other than a silane coupling agent.

(6) The substrate for a solid electrolyte capacitor as described in (5) above, wherein the additive for modifying the heat-resistant resin layer is at least one agent selected from the group consisting of a surface-tension modifier and a thixotropic agent.

(7) The substrate for a solid electrolyte capacitor as described in (5) or (6) above, wherein said solution or dispersion of a heat-resistant resin or a precursor thereof is a solution of a polyimide resin or a varnish of polyamic acid.

(8) The substrate for a solid electrolyte capacitor as described in (5) above, wherein said solution or dispersion of a heat-resistant resin or a precursor thereof is a solution of a polyimide resin or a varnish of polyamic acid, wherein said solution of polyimide resin or said varnish of polyamic acid contains 0.1% to 5% by mass, based on the mass of the solution of polyimide resin or the varnish of polyamic acid, of a silane coupling agent; and said solution of polyimide resin and said varnish of polyamic acid further contains at least one agent selected from the group consisting of a surface-tension modifier and a thixotropic agent as the additive for modifying the heat-resistant resin layer wherein the total amount of the surface-tension modifier and the thixotropic agent is in the range of 0% to 0.1% by mass, based on the solution of polyimide resin or the varnish of polyamic acid.

(9) A process for producing a solid electrolyte capacitor comprising a solid electrolyte capacitor substrate having a porous surface layer or layers on the surface or surfaces of the substrate, which substrate has a masking layer on a boundary region between an anode region of the substrate and a cathode region of the substrate, characterized by comprising the steps of:

coating the boundary region between an anode region of the substrate and a cathode region of the substrate, with a solution or dispersion of a heat-resistant resin or a precursor thereof, which solution or dispersion contains 0% to 0.1% by mass, based on the mass of the heat-resistant resin or the precursor, of an additive for modifying the masking layer, which additive is other than a silane coupling agent; and then,

drying the thus-formed coating to form the masking layer.

(10) The process for producing a solid electrolyte capacitor as described in (9) above, wherein the additive for modifying the masking layer is at least one agent selected from the group consisting of a surface-tension modifier and a thixotropic agent.

(11) The process for producing a solid electrolyte capacitor as described in (9) or (10) above, wherein said solution or dispersion of a heat-resistant resin or a precursor thereof is a solution of a polyimide resin or a varnish of polyamic acid.

(12) The process for producing a solid electrolyte capacitor as described in (9) above, wherein said solution or dispersion of a heat-resistant resin or a precursor thereof is a solution of a polyimide resin or a varnish of polyamic acid, wherein said solution of polyimide resin or said varnish of polyamic acid contains 0.1% to 5% by mass, based on the mass of the polyimide resin or the polyamic acid, of a silane coupling agent; and said solution of polyimide resin or said varnish of polyamic acid further contains at least one agent selected from the group consisting of a surface-tension modifier and a thixotropic agent as the additive for modifying the masking layer wherein the total amount of the surface-tension modifier and the thixotropic agent is in the range of 0% to 0.1% by mass, based on the solution of polyimide resin or the varnish of polyamic acid.

### EFFECT OF THE INVENTION

The solid electrolyte capacitor of the present invention has an masking layer in the boundary region between an anode region of the solid electrolyte capacitor substrate having a porous layer on the surface thereof and a cathode region of the solid electrolyte capacitor, wherein said masking layer has been formed from a liquid (i.e., a solution or dispersion) of a heat-resistant resin or a precursor thereof, which does not contain or contains only very limited amount of an additive for modifying the masking layer.

The masking layer is formed from a liquid containing a masking material comprised of a heat-resistant resin or a precursor thereof. The masking material has a function of electrically insulating an anode region of capacitor from a cathode region thereof, and preventing a solid electrolyte or a liquid for forming the solid electrolyte from penetrating from the cathode region to the anode region. The liquid of a heat-resistant resin or a precursor thereof does not contain or contains only very limited amount of an additive for modifying the masking layer, and therefore, the masking layer comprised of a masking material can be formed into a depth reaching through the porous layer to the surface of core portion of the substrate. Thus, undesirable penetration of a solid electrolyte or a liquid for forming the solid electrolyte from the cathode region to the anode region can be avoided in the course of production of the capacitor. Consequently, insulation of the cathode region from the anode region can be ensured, leakage current occurring due to insulation failure can be minimized, and the yield and reliability of capacitor are enhanced.

### BRIEF DESCRIPTION OF THE DRAWING

FIG. 1 is a diagrammatic cross-section of one example of the solid electrolyte capacitor according to the present invention.

### EXPLANATION OF REFERENCE NUMERALS

1 Anode region
2 Cathode region
3 Boundary region
4 Porous layer
5 Core
6 Masking layer (masking material layer)

### BEST MODE FOR CARRYING OUT THE INVENTION

The substrate of a solid electrolyte capacitor according to the present invention, the solid electrolyte capacitor made using the substrate, and the process for producing the solid electrolyte capacitor will be described with reference to the accompanying drawing.

The substrate of a solid electrolyte capacitor used in the present invention is comprised of a material for a capacitor and has a porous layer on the surface thereof. The substrate is preferably a substrate having micropores and comprised of a metal having a valve action, and more preferably a substrate having a dielectric oxide film on the surface thereof and comprised of a metal having a valve action. The metal having a valve action includes aluminum, tantalum, niobium, titanium, zirconium, or alloys on the basis of these metals, and the metal is selected from, for example, foils, rods and sintered bodies predominantly comprised of these metals. The metal substrate has a dielectric oxide film formed by oxidation of the surface thereof due to oxygen in the air, but, the surface of the metal substrate is usually rendered porous, for example, by etching according to the known method. The porous film is preferably subjected to a chemical formation according to the known method to ensure a definite dielectric oxide film.

The surface of the metal substrate having a valve action is preferably roughened, and then the metal substrate is cut into pieces with a desired size and shape according to the size and shape of a solid electrolyte capacitor.

The thickness of a foil of metal with a valve action varies depending upon the particular use thereof, but is generally in the range of approximately 40 to approximately 150 μm. The size and shape of the metal foil with a valve action varies depending upon the use, but the metal foil is preferably cut into a flat-sheet type element unit having a square or rectangular shape with a width of approximately 1 to 50 mm and a length of approximately 1 to 50 mm.

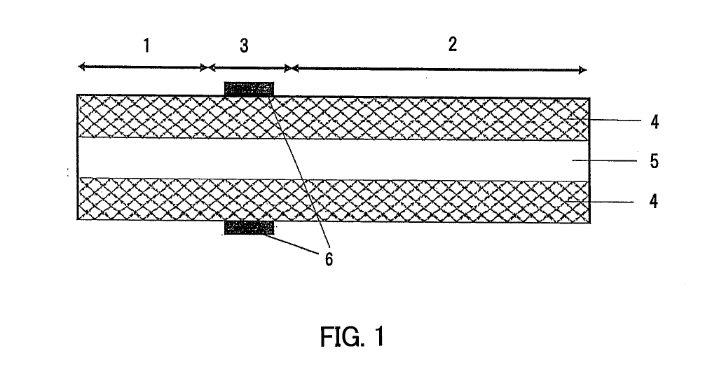

FIG. 1 is a diagrammatic cross-section of one example of the solid electrolyte capacitor according to the present invention.

The shape of the substrate for solid electrolyte capacitor is not particularly limited. As one example of the substrate, a flat-sheet type element unit prepared by etching an aluminum foil is commercially available. This flat-sheet type element unit has a core 5 comprised of aluminum and sandwiched between porous layers 4 formed by etching. In general, when the flat-sheet type element unit is used as a substrate for solid electrolyte capacitor, a region extending from one end of the element unit toward the center thereof forms an anode region 1 and a region extending from the other end of the element unit toward the center thereof forms a cathode region 2. An intermediate region 3 forms a boundary region separating the anode region 3 from the cathode region 4. A masking layer 6 comprised of the masking material used in the present invention is formed in the intermediate region 3. The masking material partly penetrates into the porous layer 4.

The masking material used includes a general heat-resistant resin, preferably soluble in or swollen with a solvent, and a precursor thereof. By the term “heat-resistant resin” as used herein, we mean a resin withstanding the heating at a reflow temperature adopted for manufacturing a capacitor. As specific examples of the heat-resistant resin, there can be mentioned polyphenylsulfone (PPS), polyethersulfone (PES), a cyanic acid ester resin, fluoro-resins such as tetrafluoroethylene and a teterafluoroethylene-perfluoroalkylvinylether copolymer, and polyimide and a precursor thereof.

Preferable masking materials include polyimide and a varnish of polyamic acid in an organic solvent (polyamic acid is a precursor of polyimide), and further include a monomer solution containing an aromatic tetracarboxylic acid and an aromatic diamine, as described in Japanese Unexamined Patent Publication No. H10-182820. The polyimide used preferably has a molecular weight in the range of 1,000 to 1,000,000, and more preferably approximately 2,000 to 800,000.

The masking material is soluble or dispersible in an organic solvent. The capacitor substrate is coated with a solution or dispersion of the masking material to form a masking layer. The solution or dispersion of the masking material having a solid concentration suitable for coating application can easily be prepared. The concentration of the solution or dispersion is preferably in the range of approximately 10 to 60% by mass and more preferably approximately 15 to 40% by mass. When the concentration or viscosity is too low, lines of the masking material tend to be blurred. In contrast, when the concentration or viscosity is too high, the solution or dispersion becomes stringy and the lines of masking material do not have a uniform width.

The coating layer of the masking material, formed by coating the substrate with the solution or dispersion of masking material, can be dried, heated or irradiated with light, if desired, to accelerate the hardening.

The solution or dispersion of masking material (heat-resistant resin or a precursor thereof) as used in the present invention is characterized as not containing, or containing up to 0.1% by mass, based on the mass of heat-resistant resin or precursor, of an additive for modifying the masking layer. This is in a striking contrast to the conventional masking material to which an additive for modifying the masking material is added. The solution or dispersion of masking material easily penetrates into the porous surface layer of the solid electrolyte capacitor substrate.

The above-mentioned solution or dispersion of masking material can be prepared by dissolving or dispersing a heat-resistant resin or a precursor thereof in an organic solvent to a solid concentration suitable for coating operation. As the heat-resistant resin or precursor, those which do not contain an additive for modifying the masking layer, are used. Further, an additive for modifying the masking layer is not incorporated in the course of production of the solution or dispersion of masking material.

The additive for modifying the masking layer, as used in the present invention, refers to an additive exhibiting a function of modifying the properties of the heat-resistant resin or precursor thereof used as the masking material, but the additive is other than a silane coupling agent. Typical examples of the additive for modifying the masking layer include a surface-tension modifier and a thixotropic agent. These surface-tension modifier and thixotropic agent are generally known as, for example, a leveling agent, an anti-foaming agent, and a coating defect-removing agent.

A surface-tension modifier includes a silicone surface-tension modifier and a non-silicone surface-tension modifier. The silicone surface-tension modifier includes, for example, silicone oils, silicone surface active agents, and synthetic silicone lubricants. The non-silicone surface-tension modifier includes, for example, lower alcohols, mineral oils, oleic acid, polypropylene glycol, glycerin higher fatty acid esters, higher alcohol boric acid esters, and fluorine-containing surface active agents. The amount of the surface-tension modifier is preferably in the range of 0 to 0.1% by mass, based on the mass of the heat-resistant resin or precursor thereof.

The thixotropic agent includes, for example, a finely divided silica powder, mica, talc and calcium carbonate. The amount of the thixotropic agent is preferably in the range of 0 to 0.1% by mass, based on the mass of the heat-resistant resin or precursor thereof.

A masking material comprising a heat-resistant resin or a precursor thereof, which have incorporated therein an additive for modifying the masking layer, is commercially available. Such commercially available masking material can be used in the present invention, provided that the additive is removed before the use.

In the case when two or more kinds of additives for modifying the masking layer are removed from a commercially available masking material (which comprises a heat-resistant resin or a precursor thereof), the additives may be removed either one after another or at once. A suitable removal ratio of the additives and suitable conditions for removal can be appropriately determined by experiments depending upon the particular properties such as micro-pore distribution of the capacitor substrate having a porous surface layer to be coated with the solution or dispersion of the masking material.

If desired, a silane coupling agent can be in the masking material. By incorporating an appropriate amount of a silane coupling agent in the masking material, a crosslinking of the resin or precursor is promoted, and an insulating masking layer having enhanced heat-resistance and high reliability can be obtained. Thus a silane coupling agent can be beneficially used in the present invention, which is in striking contrast to the other additives for modifying the masking layer, the amount of which is limited to 0 to 0.1% by weight based on the weight of the heat-resistant resin or precursor thereof.

As specific examples of the silane coupling agent, there can be mentioned tetramethoxysilane, methyltrimethoxysilane, ethyltrimethoxysilane, n-propyltrimethoxysilane, phenyltrimethoxysilane, 3-(trimethoxysilyl)propylamine, N-(2-aminoethyl)-3-aminopropyltrimethoxysilane, 3-(trimethoxysilyl)propyl methacrylate and 3-glycidoxypropyltrimethoxysilane. The amount of the silane coupling agent is preferably in the range of 0.1 to 5% by mass, more preferably 0.3 to 4% by mass, based on the mass of the heat-resistant resin or precursor thereof.

On one region of the substrate comprised of metal having a valve action, cut into a desired size and shape, the above-mentioned masking film is formed, and then, the substrate is subjected to chemical formation. The chemical formation can be effected by various methods. The conditions under which the chemical formation is carried out are not particularly limited. For example, the chemical formation can be carried out at a temperature of 0° C. to 90° C. with a current density of 0.1 mA/cm² to 200 mA/cm² using an electrolyte solution containing 0.05% to 20% by mass of at least one electrolyte selected from, for example, oxalic acid, adipic acid, boric acid and phosphoric acid. The voltage adopted in the chemical formation varies depending upon the voltage adopted for the formation of dielectric oxide film on the surface of substrate. The chemical formation time is usually within 60 minutes. More preferably, the chemical formation can be carried out at a temperature of 20° C. to 70° C. with a current density of 1 mA/cm² to 100 mA/cm² using an electrolyte solution with an electrolyte concentration of 0.1% to 15% by mass, for a time within 30 minutes.

In the above-mentioned chemical formation, the chemical formation conditions such as the kind of electrolyte, the concentration of electrolyte solution, the temperature, the current density and the chemical formation time can be arbitrarily chosen provided that the dielectric oxide film already formed on the metal substrate having a valve action is neither destroyed nor deteriorated.

The solid electrolyte includes conductive polymers having repeating structural units derived from, for example, compounds having a thiophene structure, compounds having a polycyclic sulfide structure, compounds having a pyrrole structure, compounds having a furan structure and compounds having an aniline structure.

As specific examples of the compounds having a thiophene structure, there can be mentioned 3-methylthiophene, 3-ethylthiophene, 3-propylthiophene, 3-butylthiophene, 3-pentylthiophene, 3-hexylthiophene, 3-heptylthiophene, 3-octylthiophene, 3-nonylthiophene, 3-decylthiophene, 3-fluorothiophene, 3-chlorothiophene, 3-bromothiophene, 3-cyanothiophene, 3,4-dimethylthiophene, 3,4-diethylthiophene, 3,4-butylenethiophene, 3,4-methylenedioxythiophene and 3,4-ethylenedioxythiophene. These compounds having a thiophene structure are commercially available or can be prepared by known methods (for example, a method described in Synthetic Metals, 1986, vol. 15, p 169).

The compounds having a polycyclic sulfide structure include, for example, compounds having a 1,3-dihydro-polycyclic sulfide (another name: 1,3-dihydrobenzo[c]thiophene) structure, compounds having a 1,3-dihydronaphtho[2,3-c]thiophene structure, compounds having a 1,3-dihydroanthra[2,3-c]thiophene structure and compounds having a 1,3-dihydronaphthaceno[2,3-c]thiophene structure. These compounds having a polysulfide structure can be prepared by known methods (for example, a method described in Japanese Unexamined Patent Publication No. H08-3156).

The compounds having a polycyclic sulfide structure further include, for example, compounds having a 1,3-dihydronaphtho-[1,2-c]thiophene structure, 1,3-dihydrophenanthra-[2,3-c]thiophene derivatives, compounds having a 1,3-dihydrotriphenylo[2,3-c]thiophene structure and 1,3-dihydrobenzo[a]anthraceno[7,8-c]thiophene derivatives.

Compounds having a condensed ring containing nitrogen or N-oxide may also be used, which include, for example, 1,3-dihydrothieno[3,4-b]quinoxaline, 1,3-dihydrothieno[3,4-b]-quinoxaline-4-oxide and 1,3-dihydrothieno[3,4-b]quinoxaline-4,9-dioxide.

As specific examples of the compounds having a pyrrole structure, there can be mentioned 3-methylpyrrole, 3-ethylpyrrole, 3-propylpyrrole, 3-butylpyrrole, 3-pentylpyrrole, 3-hexylpyrrole, 3-heptylpyrrole, 3-octylpyrrole, 3-nonylpyrrole, 3-decylpyrrole, 3-fluoropyrrole, 3-chloropyrrole, 3-bromopyrrole, 3-cyanopyrrole, 3,4-dimethylpyrrole, 3,4-diethylpyrrole, 3,4-butylenepyrrole, 3,4-methylenedioxypyrrole and 3,4-ethylenedioxypyrrole. These compounds having a pyrrole structure are commercially available or can be prepared by known methods.

As specific examples of the compounds having a furan structure, there can be mentioned 3-methylfuran, 3-ethylfuran, 3-propylfuran, 3-butylfuran, 3-pentylfuran, 3-hexylfuran, 3-heptylfuran, 3-octylfuran, 3-nonylfuran, 3-decylfuran, 3-fluorofuran, 3-chlorofuran, 3-bromofuran, 3-cyanofuran, 3,4-dimethylfuran, 3,4-diethylfuran, 3,4-butylenefuran, 3,4-methylenedioxyfuran and 3,4-ethylenedioxyfuran. These compounds having a furan structure are commercially available or can be prepared by known methods.

As specific examples of the compounds having an aniline structure, there can be mentioned 2-methyaniline, 2-ethylaniline, 2-propylaniline, 2-butylaniline, 2-pentylaniline, 2-hexylaniline, 2-heptylaniline, 2-octylaniline, 2-nonylaniline, 2-decylaniline, 2-fluoroaniline, 2-chloroaniline, 2-bromoaniline, 2-cyanoaniline, 2,5-dimethylaniline, 2,5-diethylaniline, 3,4-butyleneaniline, 3,4-methylenedioxyaniline and 3,4-ethylenedioxyaniline. These compounds having an aniline structure are commercially available or can be prepared by known methods.

The compounds selected from the above-recited groups of compounds may be used either alone for a homopolymer, or as a combination of two or more for a copolymer such as bipolymer or terpolymer, as the conductive polymer. When the conductive polymer is a copolymer, the composition of copolymerizable monomers varies depending upon the properties of the conductive polymer. Preferable composition of copolymerizable monomers and preferable conditions for polymerization can be determined by simple polymerization procedures.

For the production of a conductive polymer used as the solid electrolyte in the present invention, the above-mentioned monomeric compounds are polymerized in the presence of an oxidizing agent and, according to the need, further in the presence of a counter anion having a doping function.

As the oxidizing agent, those which have a function of dehydrogenative four-electron oxidation are used. More specifically, oxidizing agents which are commercially inexpensive and having good handling characteristics in the production process are conveniently used. As specific examples of the oxidizing agent, there can be mentioned iron (III) compounds such as FeCl₃, FeClO₄ and Fe-organic acid anion salts; anhydrous aluminum chloride/cuprous chloride, alkali metal persulfate salts, ammonium persulfate salts, peroxides, manganese compounds such as potassium permanganate, quinones such as 2,3-dichloro-5,6-dicyano-1,4-benzoquinone (DDQ), tetrachloro-1,4-benzoquinone and tetracyano-1,4-benzoquinone, halogens such as iodine and bromine, peracids, sulfuric acid, fuming sulfuric acid, sulfur trioxide, sulfonic acids such as chlorosulfuric acid, fluorosulfuric acid and amidosulfuric acid, and ozone. These oxidizing agents may be used either alone or as a combination of at least two thereof.

Among the above-recited compounds, the organic acid anion for forming the Fe-organic acid anion salts includes anions of, for example, organic sulfonic acids, organic carboxylic acids, organic phosphoric acids and organic boric acids.

As specific examples of the organic sulfonic acids, there can be mentioned benzenesulfonic acid, p-toluenesulfonic acid, methanesulfonic acid, ethanesulfonic acid, α-sulfonaphthalene, β-sulfonaphthalene, naphthalenedisulfonic acid and alkylnaphthalenesulfonic acid (the alkyl group includes, for example, butyl, triisopropyl and di-t-butyl groups).

As specific examples of the organic carboxylic acids, there can be mentioned acetic acid, propionic acid, benzoic acid and oxalic acid. Further, polymeric electrolyte anions such as polyacrylic acid, polymethacrylic acid, polystyrenesulfonic acid, polyvinylsulfonic acid, polyvinylsulfuric acid, poly-α-methylsulfuric acid, polyethylenesulfonic acid and polyphosphoric acid may also be used.

The above-recited organic sulfonic acids and organic carboxylic acids are mere exemplification, and the organic sulfonic acids and organic carboxylic acids are not limited thereto.

Counter cations for the above-recited anions are not particularly limited, and include, for example, H⁺, alkali metal ions such as Na⁺ and K⁺, and ammonium ions having hydrogen atom, or tetramethyl, tetraethyl, tetrabutyl or tetraphenyl groups.

Of the above-recited oxidizing agents, Fe (III) compounds, cuprous chloride compounds, alkali metal persulfate salts, ammonium persulfate salts, manganese compounds and quinones are preferably used.

As the counter anion having a doping function optionally used in the production of a conductive polymer as the solid electrolyte in the present invention, electrolyte compounds having, as a counter ion, oxidizing agent anions produced from the above-mentioned oxidizing agents (i.e, reduction products of oxidizing agents), and other anionic electrolytes. As specific examples of the counter anion having a doping function, there can be mentioned anions of halogenated group 5B elements such as PF₆⁻, SbF₆⁻ and ASF₆⁻; anions of halogenated group 3B elements such as BF₄⁻; halogen anions such as I⁻ (I₃⁻), Br⁻ and Cl⁻; halogen acid anions such as ClO₄⁻; Lewis acid anions such as AlCl₄⁻, FeCl₄⁻ and SnCl₅⁻; and, protonic acid anions including inorganic acid anions such as NO₃⁻ and SO₄²⁻; organic sulfonic acid anions such as anions of p-toluenesulfonic acid, naphthalenesulfonic acid, C₁₋₅ alkyl-substituted sulfonic acids, CH₃SO₃⁻ and CF₃SO₃⁻; and carboxylic acid anions such as CF₃COO⁻ and C₆H₅COO⁻. The counter anions further include polymer electrolyte anions such as, for example, polyacrylic acid, polymethacrylic acid, polystyrenesulfonic acid, polyvinylsulfonic acid, polyvinyl-sulfuric acid, poly-α-methylsulfonic acid, polyethylenesulfonic acid and polyphosphoric acid. The counter anion having a doping function is not particularly limited to those which are recited above.

As the counter anion having a doping function, high-molecular-weight or low-molecular-weight organic sulfonic acid compounds and polyphosphoric acid are preferably used. Arylsulfonate salt dopants are especially preferably used, which include, for example, benzenesulfonic acid, toluenesulfonic acid, naphthalenesulfonic acid, anthracenesulfonic acid and anthraquinonesulfonic acid, and their derivatives.

The concentration of the monomers, which are used for the preparation of conductive polymers as solid electrolyte substrates in the present invention, varies depending upon the substituent of the monomer and the solvent, but, the monomer concentration is generally preferably in the range of 10⁻³ to 10 moles/liter, more preferably 10⁻² to 5 moles/liter. The temperature for polymerization reaction is not particularly limited, and varies depending upon the polymerization procedure. However, the temperature is usually in the range of −70° C. to 250° C., preferably −30° C. to 150° C., and more preferably −10° C. to 30° C.

As the solvent for polymerization reaction, those are used which are capable of dissolving the respective monomers, oxidizing agent, counter anion having a doping function, or a mixture of these materials. As specific examples of the solvent, there can be mentioned ethers such as tetrahydrofuran, dioxane and diethyl ether; aprotic polar solvents such as dimethylformamide, acetonitrile, benzonitrile, N-methylpyrrolidone and dimethylsulfoxide; esters such as ethyl acetate and butyl acetate; non-aromatic chlorine-containing solvents such as chloroform and methylene chloride; nitro compounds such as nitromethane, nitroethane and nitrobenzene; alcohols such as methanol, ethanol and propanol; organic acids such as formic acid, acetic acid and propionic acid; anhydrides of these organic acids (for example, acetic anhydride); water; and ketones. These solvents may be used either alone or as a mixed solvent comprised of at least two thereof.

The above-mentioned oxidizing agent, counter anion having a doping function, and/or monomers may be used as two or three solutions having each of the ingredients dissolved therein.

The thus-produced solid electrolyte usually has a conductivity of at least 1 S/cm, preferably at least 5 S/cm and more preferably 10 S/cm.

A carbon paste layer and a metal powder-containing conductive layer are formed on a surface of the solid electrolyte to constitute a cathode region of the capacitor. The metal powder-containing conductive layer adheres to the solid electrolyte, and has a function as a cathode and as an intervening adhesive layer for adhering a cathode lead terminal to a capacitor as an end-product. The thickness of the metal powder-containing conductive layer is not particularly limited, but is usually in the range of approximately 1 to 100 μm, preferably 5 to 50 μm.

The solid electrolyte substrates according to the present invention are usually assembled into a multilayer capacitor element. In a multilayer solid electrolyte capacitor, a lead frame can be beveled, i.e., the ridge of lead frame may be cut at an inclination angle so as to be round. Confronting cathode bonded parts on a lead frame can be functioned as lead terminals.

The lead frame can be made from metallic materials conventionally used without limitation, but is preferably made from copper-containing metallic materials or a material plated with a copper-containing metallic material. The copper-containing metallic material includes, for example, alloys of Cu—Ni, Cu—Ag, Cu—Sn, Cu—Fe, Cu—Ni—Ag, Cu—Ni—Sn, Cu—Co—P, Cu—Zn—Mg and Cu—Sn—Ni—P. By constituting the lead frame from these metallic materials, the lead frame can be easily beveled.

The solid electrolyte capacitor can be manufactured by a process wherein a lead terminal is bonded to the anode region of capacitor, and a lead is bonded to the cathode region of capacitor, comprised of a solid electrolyte layer, a carbon paste layer and a metal powder-containing conductive layer, and finally the thus-obtained assembly is encapsulated with an insulating resin such as an epoxy resin.

The solid electrolyte capacitor according to the present invention is not particularly limited to the above-mentioned constitution of capacitor and solid electrolyte, provided that the solid electrolyte capacitor is made from the substrate for solid electrolyte capacitor having a porous layer on the surface thereof.

### EXAMPLES

The present invention will be described specifically and in detail by the following working examples.

### Example 1

A chemically formed aluminum foil with a thickness of 110 μm (formation voltage: 3V) was cut into strips each with a width of 3.5 mm and a length of 13 mm. One end of each strip was fixed to a metal guide by welding. A polyimide solution having a concentration of 40% by mass was coated in a linear form with a width of 0.8 mm at a position 7 mm apart from the other end (i.e., an end other than the fixed end), and the linear coating was dried at approximately 180° C. for 30 minutes to form a linear masking. The polyimide solution used contained 40% by mass of polyimide resin, and further contained, based on the mass of the polyimide resin, 0.09% by mass of polyether-modified silicone oil (surface tension adjuster, available from Shin-Etsu Chemical Co., Ltd.) and 1.0% by mass of silane-coupling agent (3-glycidoxypropyltrimethoxy-silane), but, did not contain a thixotropic agent nor other masking layer-modifying agent.

A portion of each fixed strip spanning from the non-fixed end to the linear polyimide masking was subjected to a first chemical forming treatment with an aqueous oxalic solution with a 5% by mass concentration at a current density of 5 mA/cm², a formation voltage of 3 V and a temperature of 25° C. for 2 minutes, and washed with water and then dried.

Thereafter the chemically formed portion was subjected to a second chemical forming treatment with an aqueous sodium silicate solution with a 1% by mass concentration at a current density of 1 mA/cm², a formation voltage of 3 V and a temperature of 65° C. for 7 minutes, and washed with water and then dried in a similar manner. Thereafter the chemically formed strip was heat-treated at 300° C. for 30 minutes.

The chemically formed portion was subjected to a third chemical forming treatment with an aqueous ammonium adipate solution with a 9% by mass concentration at a current density of 3 mA/cm², a formation voltage of 3 V and a temperature of 65° C. for 10 minutes, and washed with water and then dried in a similar manner.

Thereafter a polyimide solution was coated in a linear form with a width of 0.8 mm at a position such that the center line of the 0.8 mm wide line is 5 mm apart from the non-fixed end of the chemically formed strip, and the linear coating was dried at 180° C. for 1 hour to form a border line for dividing an anode portion of capacitor and a cathode portion thereof.

An solid electrolyte for forming a cathode layer was formed in the cathode portion with a size of 3.5 mm×4.6 mm as follows.

The cathode portion was dipped in a solution (solution 1) of 3,4-ethylenedioxythiophene (monomer) in isopropanol, pulled up, and then left standing. Then the cathode portion was dipped in an aqueous solution (solution 2) containing ammonium persulfate, and then dried to conduct oxidative polymerization. The oxidative polymerization procedure of dipping with solution 1 and then dipping with solution 2 and dried was repeated.

The strip subjected to the oxidative polymerization was washed with warm water at 50° C. and then dried at 100° C. to form a solid electrolyte layer. The cathode portion was coated with a carbon paste and then with a silver paste to form an electrode, thus making a capacitor element.

Two capacitor elements were stacked on a lead frame in a manner such that the portion of the coated polyimide masking material of each capacitor element was adhered with a silver paste to the lead frame, and an anode lead terminal was connected by welding to the portion of the capacitor element, on which the solid electrolyte had not been formed. The thus-obtained assembly was encapsulated with an epoxy resin, and was aged at 135° C. while a voltage of 2V was applied. Thus, 30 capacitors in total were manufactured.

Initial characteristics of the 30 capacitors were evaluated as follows. The evaluated initial characteristics were capacitance at 120 Hz, loss factor (tan δ) at 120 Hz, equivalent series resistance (hereinafter referred to “ESR”) at 100 kHz, and leakage current. The leakage current was measured when 1 minute elapsed after a rated voltage of 16 V was applied. The measurement results were as follows.

Capacitance (average value): 94.0 μF

Loss factor (tan δ) (average value): 1.0%

ESR (average value): 10.6 mΩ

Leakage current (average value): 0.16 μA

The fraction defective was 10% as evaluated by rating a capacitor exhibiting a leakage current of 1 μA (0.005 CV) or larger as a defective.

Further the characteristics were evaluated by carrying out a reflow test and subsequently a moisture resistance test. The reflow test (also referred to as soldering heat resistance test) was conducted as follows. Twenty capacitors were provided and the capacitors were passed through a zone maintained at 255° C. over 10 seconds. This reflow operation was repeated 3 times, and thereafter, the leakage current was measured when 1 minute elapsed after the rated voltage was applied. The leakage current of 8 μA (0.04 CV) or larger was rated as a defective. The moisture resistance test was conducted as follows. Capacitors were left to stand under high-temperature high-humidity conditions of 60° C. and 90% RH for 500 hours, and then, the leakage current was measured when 1 minute elapsed after the rated voltage was applied. The leakage current of 80 μA (0.4 CV) or larger was rated as a defective. The measurement results were as follows.

Leakage current as measured after reflow test: 0.19 μA

Leakage current assilane measured after moisture resistance test: 9.6 μA

The fraction defectives as evaluated after the reflow test and after the moisture resistance test were 0%.

The evaluation results are shown in Tables 1 and 2. Evaluation results obtained in the following examples and comparative examples are also shown in Tables 1 and 2.

### Example 2

Capacitors were made and their characteristics were evaluated by the same procedures as mentioned in Example 1 except that the following polyimide solution was used as a masking agent instead of the polyimide solution used in Example 1. The polyimide solution used in this example contained 40% by mass of polyimide resin, and further contained, based on the mass of the polyimide resin, 0.09% by mass of a thixotropic agent (finely divided silica powder) and 1.0% by mass of silane-coupling agent (3-glycidoxypropyltrimethoxysilane), but, did not contain a surface tension adjuster nor other masking layer-modifying agent. All other procedures and conditioned remained the same.

### Example 3

Capacitors were made and their characteristics were evaluated by the same procedures as mentioned in Example 1 except that the following polyimide solution was used as a masking agent instead of the polyimide solution used in Example 1. The polyimide solution used in this example contained 40% by mass of polyimide resin, and further contained, based on the mass of the polyimide resin, and 1.0% by mass of silane-coupling agent (3-glycidoxypropyltrimethoxysilane), but, did not contain a surface tension adjuster, a thixotropic agent nor other masking layer-modifying agent. All other procedures and conditioned remained the same.

### Example 4

Capacitors were made and their characteristics were evaluated by the same procedures as mentioned in Example 1 except that the following polyimide solution was used as a masking agent instead of the polyimide solution used in Example 1. The polyimide solution used in this example contained 40% by mass of polyimide resin, but did not contain a surface tension adjuster, a thixotropic agent nor any masking layer-modifying agent. All other procedures and conditioned remained the same.

### Comparative Example 1

Capacitors were made and their characteristics were evaluated by the same procedures as mentioned in Example 1 except that the following polyimide solution was used as a masking agent instead of the polyimide solution used in Example 1. The polyimide solution used in this comparative example contained 40% by mass of polyimide resin, and further contained, based on the mass of the polyimide resin, 0.11% by mass of polyether-modified silicone oil (surface tension adjuster, available from Shin-Etsu Chemical Co., Ltd.) and 1.0% by mass of silane-coupling agent (3-glycidoxypropyltrimethoxysilane), but, did not contain a thixotropic agent nor other masking layer-modifying agent. All other procedures and conditioned remained the same.

### Comparative Example 2

Capacitors were made and their characteristics were evaluated by the same procedures as mentioned in Example 1 except that the following polyimide solution was used as a masking agent instead of the polyimide solution used in Example 1. The polyimide solution used in this comparative example contained 40% by mass of polyimide resin, and further contained, based on the mass of the polyimide resin, 0.11% by mass of a thixotropic agent (finely divided silica powder) and a silane-coupling agent (3-glycidoxypropyltrimethoxysilane), but, did not contain a surface tension adjuster nor other masking layer-modifying agent. All other procedures and conditioned remained the same.

TABLE 1
Initial Characteristics of Capacitor

| | Initial Characteristics | | | | | |
|---|---|---|---|---|---|---|
| | | Loss | | Leakage | | No. of |
| | Capacitance | factor | ESR | current | Defective | short |
| Examples | μF | % | mΩ | μA | % | circuit *1 |
| Example 1 | 94.0 | 1.0 | 10.6 | 0.16 | 2 | 0 |
| Example 2 | 94.3 | 1.0 | 10.1 | 0.14 | 1 | 0 |
| Example 3 | 94.5 | 1.1 | 9.9 | 0.13 | 1 | 0 |
| Example 4 | 94.1 | 1.1 | 10.2 | 0.15 | 1 | 0 |
| Com. | 94.2 | 1.2 | 11.4 | 0.27 | 5 | 1 |
| Ex. 1 | | | | | | |
| Com. | 94.0 | 1.2 | 10.9 | 0.35 | 7 | 2 |
| Ex. 2 | | | | | | |

*1 Number of short circuited capacitors

TABLE 2
Reliability of Capacitor

| | Reflow test | | | Moisture resistance test | | |
|---|---|---|---|---|---|---|
| | Leak- | | | Leak- | | |
| | age | No. of | No. of | age | No. of | No. of |
| | current | defec- | short | current | defec- | short |
| Examples | μA | tives | circuit *1 | μA | tives | circuit *1 |
| Example 1 | 0.19 | 0 | 0 | 9.6 | 0 | 0 |
| Example 2 | 0.35 | 0 | 0 | 12.6 | 0 | 0 |
| Example 3 | 0.24 | 0 | 0 | 11.8 | 0 | 0 |
| Example 4 | 0.32 | 0 | 0 | 10.3 | 0 | 0 |
| Com. | 0.89 | 4 | 2 | 25.6 | 3 | 4 |
| Ex. 1 | | | | | | |
| Com. | 0.98 | 4 | 3 | 31.5 | 4 | 4 |
| Ex. 2 | | | | | | |

*1 Number of short circuited capacitors

As seen from Table 2, the solid electrolyte capacitor of the present invention exhibits a reduced leakage current and a reduced defective percents, and thus, the yield and reliability are greatly enhanced.

### INDUSTRIAL APPLICABILITY

The solid electrolyte capacitor of the present invention has an masking layer in the boundary region between an anode region of the solid electrolyte capacitor substrate having a porous layer on the surface thereof and a cathode region of the solid electrolyte capacitor, wherein said masking layer has been formed from a liquid of a heat-resistant resin or a precursor thereof, which does not contain or contains not larger than 0.1% by mass (based on the mass of the heat-resistant resin or a precursor thereof) of an additive for modifying the masking layer.

Consequently, the masking material has a function of preventing a solid electrolyte or a liquid for forming the solid electrolyte, from penetrating from a cathode region of capacitor to an anode region thereof, and thus, exhibits a highly enhanced insulation between the cathode region and the anode region. This leads to a great reduction of leakage current occurring due to insulation failure, and a great enhancement in the yield and reliability of capacitor.

The solid electrolyte capacitor of the present invention can be used in a wide field which is similar to that wherein the conventional capacitor made from a substrate for a solid electrolyte capacitor is used.

1. A solid electrolyte capacitor comprising a solid electrolyte capacitor substrate having a porous surface layer or layers on the surface or surfaces of the substrate, which substrate has a masking layer on a boundary region between an anode region of the substrate and a cathode region of the substrate, characterized in that said masking layer is formed from a solution or dispersion of a heat-resistant resin or a precursor thereof; and said masking layer contains 0% to 0.1% by mass, based on the mass of the heat-resistant resin or the precursor, of an additive for modifying the masking layer, which additive is other than a silane coupling agent.

2. The solid electrolyte capacitor according to claim 1, wherein the additive for modifying the masking layer is at least one agent selected from the group consisting of a surface-tension modifier and a thixotropic agent.

3. The solid electrolyte capacitor according to claim 1, wherein said solution or dispersion of a heat-resistant resin or a precursor thereof is a solution of a polyimide resin or a varnish of polyamic acid.

4. The solid electrolyte capacitor according to claim 1, wherein said solution or dispersion of a heat-resistant resin or a precursor thereof is a solution of a polyimide resin or a varnish of polyamic acid, wherein said solution of polyimide resin or said varnish of polyamic acid contains 0.1% to 5% by mass, based on the mass of the polyimide resin or the polyamic acid, of a silane coupling agent; and said solution of polyimide resin or said varnish of polyamic acid further contains at least one agent selected from the group consisting of a surface-tension modifier and a thixotropic agent as the additive for modifying the masking layer wherein the total amount of the surface-tension modifier and the thixotropic agent is in the range of 0% to 0.1% by mass, based on the mass of the solution of polyimide resin or the varnish of polyamic acid.

5. A substrate for a solid electrolyte capacitor which substrate has a porous surface layer or layers on the surface or surfaces of the substrate, and has a heat-resistant resin layer formed on at least part of the substrate, characterized in that said heat-resistant resin layer is formed from a solution or dispersion of a heat-resistant resin or a precursor thereof, wherein said heat-resistant resin layer contains 0% to 0.1% by mass, based on the mass of the heat-resistant resin or the precursor, of an additive for modifying the heat-resistant resin layer, which additive is other than a silane coupling agent.

6. The substrate for a solid electrolyte capacitor according to claim 5, wherein the additive for modifying the heat-resistant resin layer is at least one agent selected from the group consisting of a surface-tension modifier and a thixotropic agent.

7. The substrate for a solid electrolyte capacitor according to claim 5, wherein said solution or dispersion of a heat-resistant resin or a precursor thereof is a solution of a polyimide resin or a varnish of polyamic acid.

8. The substrate for a solid electrolyte capacitor according to claim 5, wherein said solution or dispersion of a heat-resistant resin or a precursor thereof is a solution of a polyimide resin or a varnish of polyamic acid, wherein said solution of polyimide resin or said varnish of polyamic acid contains 0.1% to 5% by mass, based on the mass of the solution of polyimide resin or the varnish of polyamic acid, of a silane coupling agent; and said solution of polyimide resin and said varnish of polyamic acid further contains at least one agent selected from the group consisting of a surface-tension modifier and a thixotropic agent as the additive for modifying the heat-resistant resin layer wherein the total amount of the surface-tension modifier and the thixotropic agent is in the range of 0% to 0.1% by mass, based on the solution of polyimide resin or the varnish of polyamic acid.

9. A process for producing a solid electrolyte capacitor comprising a solid electrolyte capacitor substrate having a porous surface layer or layers on the surface or surfaces of the substrate, which substrate has a masking layer on a boundary region between an anode region of the substrate and a cathode region of the substrate, characterized by comprising the steps of:
coating the boundary region between an anode region of the substrate and a cathode region of the substrate, with a solution or dispersion of a heat-resistant resin or a precursor thereof, which solution or dispersion contains 0% to 0.1% by mass, based on the mass of the heat-resistant resin or the precursor, of an additive for modifying the masking layer, which additive is other than a silane coupling agent; and then,
drying the thus-formed coating to form the masking layer.

10. The process for producing a solid electrolyte capacitor according to claim 9, wherein the additive for modifying the masking layer is at least one agent selected from the group consisting of a surface-tension modifier and a thixotropic agent.

11. The process for producing a solid electrolyte capacitor according to claim 9, wherein said solution or dispersion of a heat-resistant resin or a precursor thereof is a solution of a polyimide resin or a varnish of polyamic acid.

12. The process for producing a solid electrolyte capacitor according to claim 9, wherein said solution or dispersion of a heat-resistant resin or a precursor thereof is a solution of a polyimide resin or a varnish of polyamic acid, wherein said solution of polyimide resin or said varnish of polyamic acid contains 0.1% to 5% by mass, based on the mass of the polyimide resin or the polyamic acid, of a silane coupling agent; and said solution of polyimide resin or said varnish of polyamic acid further contains at least one agent selected from the group consisting of a surface-tension modifier and a thixotropic agent as the additive for modifying the masking layer wherein the total amount of the surface-tension modifier and the thixotropic agent is in the range of 0% to 0.1% by mass, based on the solution of polyimide resin or the varnish of polyamic acid.
